(19) United States
(12) Patent Application Publication
(10) Pub. No.: US 2016/0313442 A1
(43) Pub. Date: Oct. 27, 2016

(54) MONITORING SYSTEM, APPARATUS AND METHOD THEREOF

(71) Applicant: HTC Corporation, Taoyuan City (TW)

(72) Inventors: Chien-Ting Ho, Taoyuan City (TW); Yen-Liang Kuo, Taoyuan City (TW); Chih-Jen Hu, Taoyuan City (TW)

(21) Appl. No.: 14/691,585

(22) Filed: Apr. 21, 2015

(51) Int. Cl. G01S 13/88; G01S 7/00; G01S 13/86

(52) U.S. Cl. CPC G01S 13/88; G01S 13/867; G01S 7/003

(57) ABSTRACT

A monitoring system, a monitoring apparatus, and a monitoring method thereof are provided. In particular, the monitoring system includes a handheld electronic apparatus and a monitoring apparatus. The monitoring apparatus is wirelessly connected to the handheld electronic apparatus. The monitoring apparatus includes a radar, an image capture unit, and a processing unit. The radar generates an electromagnetic wave and receives a reflected wave of the electromagnetic wave. The image capture unit is configured to capture a plurality of image. The processing unit generates a status information according to the reflected wave of the electromagnetic wave and the image, and wirelessly transmits the status information to the handheld electronic apparatus. The handheld electronic apparatus triggers a function according to the status information.

### BACKGROUND OF THE INVENTION

1. Field of the Invention

The invention relates to a monitoring system, a monitoring apparatus, and a monitoring method thereof, and more particularly, to a no-contact monitoring system and monitoring apparatus, and a monitoring method thereof.

2. Description of Related Art

With changes in the social environment, the phenomenon of low birth rate is increasing, and the care for a newborn infant is receiving more and more attention. When caring for a newborn infant, in addition to paying attention to emotional reactions thereof such as crying at all times and providing appropriate care, care also must be taken with the physiological characteristics of the newborn infant. In particular, the sudden infant death syndrome (SIDS) occurring in many cases is the worst nightmare of every newborn infant's parent. The newborn infant may experience a phenomenon such as discontinued breathing or suffocation due to causes such as ambient temperature (such as a weather that is too cold or too hot), posture during sleep (such as sleeping face-down), or spilled milk during sleep, thereby resulting in unfortunate consequences.

However, if a method can be provided that allows for constant monitoring of a change (such as change in posture) in a characteristic such as the posture or the breathing condition of the newborn infant, appropriate measures can be taken immediately when the posture of the newborn infant is poor or the breathing of the newborn infant is abnormal, thus preventing danger to the newborn infant. Therefore, how to monitor the condition of a newborn infant at all times in a convenient manner is an import current topic.

### SUMMARY OF THE INVENTION

The invention provides a monitoring system, a monitoring apparatus, and a monitoring method thereof capable of generating a status information according to radar detection or image of a monitored object, and providing the status information to a user without the constraint of time and space so as to effectively monitor the status of the object.

A monitoring system of the invention includes a handheld electronic apparatus and a monitoring apparatus. The monitoring apparatus is wirelessly connected to the handheld electronic apparatus. The monitoring apparatus includes a radar, an image capture unit, and a processing unit. The radar generates an electromagnetic wave and receives a reflected wave of the electromagnetic wave. The image capture unit is configured to capture a plurality of image. The processing unit is coupled to the radar and the image capture unit, and generates a status information according to the reflected wave of the electromagnetic wave and the image, and wirelessly transmits the status information to the handheld electronic apparatus. The handheld electronic apparatus triggers a function according to the status information.

In an embodiment of the invention, the monitoring apparatus further includes an apparatus control unit. The apparatus control unit is coupled to the processing unit and controls a plurality of electronic apparatuses. In particular, the handheld electronic apparatus generates a control signal according to the status information. The monitoring apparatus controls the electronic apparatuses via the apparatus control unit according to the control signal.

The monitoring apparatus of the invention includes a radar, an image capture unit, and a processing unit. The radar generates an electromagnetic wave and receives a reflected wave of the electromagnetic wave. The image capture unit is configured to capture a plurality of image. The processing unit is coupled to the radar and the image capture unit, and generates a status information according to the reflected wave of the electromagnetic wave and the image, and wirelessly transmits the status information to the handheld electronic apparatus. The handheld electronic apparatus triggers a function according to the status information.

A monitoring method of the invention includes: generating an electromagnetic wave to receive a reflected wave of the electromagnetic wave, and capturing a plurality of image; generating a status information according to the reflected wave of the electromagnetic wave and the image; and triggering a function according to the status information.

Based on the above, the monitoring system of the invention can monitor a change in a characteristic of an object via a radar electromagnetic wave in a no-contact manner, and determine the physical condition of the object with the image. Moreover, the determination results are transmitted to the handheld electronic apparatus so that a user can be always in control of the condition of the object in a convenient manner and take appropriate measures, thus keeping the object from discomfort or danger.

In order to make the aforementioned features and advantages of the disclosure more comprehensible, embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 illustrates a schematic of a monitoring system of an embodiment of the invention.

FIG. 2 illustrates a schematic of a monitoring system of another embodiment of the invention.

FIG. 3 illustrates a schematic of a temperature detector of an embodiment of the invention.

FIG. 4 illustrates a schematic of the implementation of temperature detection of an embodiment of the invention.

FIG. 5 illustrates a schematic of the implementation of the control of an electronic apparatus of an embodiment of the invention.

FIG. 6 illustrates a flow chart of a monitoring method of an embodiment of the invention.

FIG. 7 illustrates a flow chart of a monitoring method of an embodiment of the invention.

FIG. 8 illustrates a flow chart of a monitoring method of an embodiment of the invention.

FIG. 9 illustrates a flow chart of a monitoring method of an embodiment of the invention.

### DESCRIPTION OF THE EMBODIMENTS

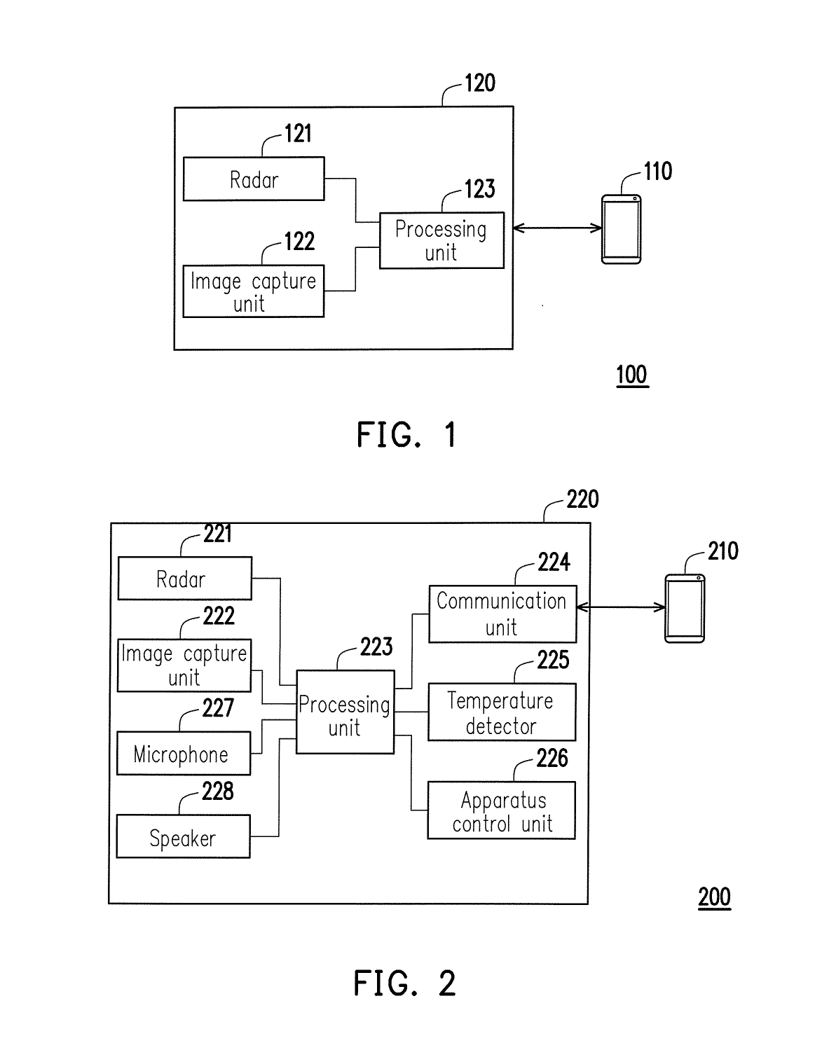

Referring to FIG. 1, FIG. 1 illustrates a schematic of a monitoring system of an embodiment of the invention. A monitoring system 100 includes a handheld electronic apparatus 110 and a monitoring apparatus 120. The handheld electronic apparatus 110 can be, for instance, an electronic apparatus that can be handheld and carried around by a user in a convenient manner such as a smart phone, a personal digital assistant (PDA), a PDA mobile phone, or a tablet computer. The monitoring apparatus 120 is, for instance, a computing apparatus having the functions of image capture and radar detection, and can be wirelessly connected to the handheld electronic apparatus 110 via a method such as internet (including cloud service), bluetooth communication, near field communication (NFC), or wireless fidelity (WiFi) communication.

The monitoring apparatus 120 includes a radar 121, an image capture unit 122, and a processing unit 123. The radar 121 is, for instance, an active radar apparatus. In implementation, the radar 121 can generate an electromagnetic wave and directionally transmit the electromagnetic wave to the environmental space that the detected object is located. The electromagnetic wave transmitted to the detected object generates a reflected wave in correspondence to the shielding effect of the detected object. The radar 121 can monitor changes in various characteristics of the object by receiving the reflected wave of the electromagnetic wave and according to the properties of the electromagnetic wave (such as direction and frequency).

Specifically, after the radar 121 receives the reflected wave, analysis can be performed to at least obtain information such as the location, the movement speed, the rising and falling movements of the object from breathing, and the three-dimensional shape of the detected object. Moreover, the radar 121 can calculate changes (such as the posture maintained by the object, respiratory rate, and heart rate) in various characteristics of the object from the above information, so as to monitor the object.

For instance, the radar 121 can be an ultra wide spectrum radar, also referred to as an ultra wide band (UWB) radar. An ultra wide spectrum radar irradiates a detected object with a microwave beam in the form of a pulse, and due to the presence of life activity (such as breathing, heartbeat, or intestinal motility) of the detected object, the cycle of the pulse sequence of the reflected wave of the object generated after reflectance can be repeated to induce a change, and via such as change, the radar 121 can effectively measure a change of the object.

Of course, the radar 121 is not limited to an ultra wide spectrum radar, and any radar capable of detecting a characteristic of an object can be applied in the invention.

The image capture unit 122 is, for instance, an apparatus containing a photosensitive device such as an optical fixed focus lens or an optical zoom lens, and a charge-coupled device (CCD) or a complementary metal-oxide semiconductor (CMOS) device, and in the present embodiment, the image capture unit 122 is configured to capture a plurality of image containing the detected object.

The processing unit 123 is, for instance, a central processing unit (CPU) having a single-core or a multi-core, or other programmable general purpose or special purpose microprocessors, digital signal processors (DSP), or programmable controllers. The processing unit 123 is coupled to the radar 121 and the image capture unit 122. The processing unit 123 can determine a change of the object according to the reflected wave received by the radar 121 and the image (or at least one thereof) captured by the image capture unit 122 to generate a corresponding status information, and wirelessly transmit the status information to the handheld electronic apparatus 110. Accordingly, the handheld electronic apparatus 110 can trigger a related function according to the received status information. For instance, the radar 121 can monitor the respiratory rate or the heart rate of the object via the received reflected wave and transmit the results to the processing unit 123. The image capture unit 122 can capture image of an object to obtain the body posture of the object (such as sleeping face-down or face-up), and transmit the image to the processing unit 123. Accordingly, the processing unit 123 can determine whether the posture of the object is poor according to the respiratory rate or the heart rate of the object and the current image of the object so as to generate the corresponding status information, and thereby monitor an object (such as a newborn infant, an elderly, or a patient) via the handheld electronic apparatus 123 triggering a related function. It should be mentioned that, in addition to the application of monitoring a human body, in some embodiments, the monitoring system 100 of an embodiment of the invention can also be applied in other objects such as the monitoring of a pet such as a cat or a dog, and the embodiments of the invention are not limited thereto.

In actual operation, the processing unit 123 can determine that the respiratory rate of a detected infant is reduced according to a change in a characteristic monitored by the radar 121, and the processing unit 123 can further learn that a phenomenon of breathing difficulty occurs to the infant from turning or a foreign object (such as a comforter) blocking the respiratory path (mouth, nose) according to the radar 121 and the image of the object captured by the image capture unit 122, and at this point, the monitoring apparatus 120 can send a warning signal to the handheld electronic apparatus 110 to inform the caregiver that the detected infant may require assistance. Moreover, the monitoring apparatus 120 can also transmit the captured image to the handheld electronic apparatus 110 such that the caregiver can view the status of the child so that the caregiver can have better knowledge of the status of the child.

Referring to FIG. 2 in the following, FIG. 2 illustrates a schematic of a monitoring system of another embodiment of the invention. A monitoring system 200 includes a handheld electronic apparatus 210 and a monitoring apparatus 220. The monitoring apparatus 220 includes a radar 221, an image capture unit 222, a processing unit 223, a communication unit 224, a temperature detector 225, an apparatus control unit 226, a microphone 227, and a speaker 228. In particular, the functions of a portion of the devices are the same as or similar to the functions of corresponding devices in the above embodiments, and therefore details thereof are not repeated herein.

In the present embodiment, the communication unit 224 is coupled to the processing unit 223. The communication unit 224 is, for instance, any type of communication device/circuit capable of supporting internet (including cloud service), bluetooth communication, near field communication, or wireless fidelity communication. A connection can be established between the communication unit 224 and the handheld electronic apparatus 210. Via the establishment of the above connection, the processing unit 223 can transmit the generated status information to the handheld electronic apparatus 210 via the communication unit 224.

The temperature detector 225 is coupled to the processing unit 223. The temperature detector 225 is, for instance, any type of sensing device/circuit having the function of temperature detection. The temperature detector 225 can detect the temperature of the object as one type of change of the object, such that the processing unit 233 can accordingly determine the physical condition of the object.

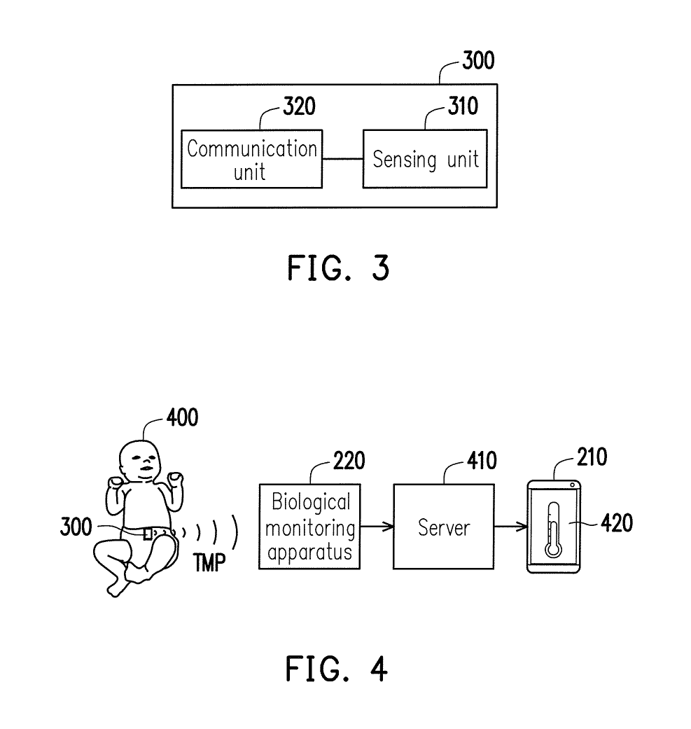

In an embodiment, the temperature detector can be disposed in a location adjacent to the detected object to increase the accuracy of temperature detection. FIG. 3 illustrates a schematic of a temperature detector of an embodiment of the invention.

Referring to FIG. 3, a temperature detector 300 is, for instance, an infrared temperature detector, and can be disposed isolated from the object, such as disposed on the diaper of a newborn infant to prevent direct skin contact and causing discomfort, and be configured to detect the temperature of the object.

In the present embodiment, the temperature detector 300 includes a sensing unit 310 and a communication unit 320. The sensing unit 310 can sense the temperature of the object to generate a corresponding temperature information. The function and the structure of the communication unit 320 are the same as or similar to those of the communication unit 224, and a connection between the communication unit 320 and the communication unit 224 can be established such that the temperature information generated by the sensing unit 310 can be transmitted to the monitoring apparatus 220.

In the following, an example of temperature detection for an object is described with reference to FIG. 2, FIG. 3, and FIG. 4, wherein FIG. 4 illustrates a schematic of implementation of temperature detection of an embodiment of the invention. In FIG. 4, the temperature detector 300 can be disposed isolated from an object (exemplified by a newborn infant in FIG. 4) 400 (such as disposed on a diaper). When the monitoring apparatus 220 is monitoring the object 400, the temperature detector 300 can detect the temperature of the object 400 via the sensing unit 310 without direct contact with the object 400, and transmit a temperature information TMP to the communication unit 224 of the monitoring apparatus 220 via the communication unit 320 through, for instance, a bluetooth communication method.

After the monitoring apparatus 220 receives the temperature information TMP via the temperature detector 300, the monitoring apparatus 220 can generate the corresponding status information according to the temperature of the object 400, and transmit the status information to the handheld electronic apparatus 210 via the communication unit 224 through the server 410 (such as a cloud server) wirelessly connected to the monitoring apparatus 220. Accordingly, the handheld electronic apparatus 210 can receive the status information via the server 410, and execute an application 420 (as shown in FIG. 4, an image displaying a thermometer) corresponding to the status information to execute a related function and monitor the temperature of the object 400.

In another embodiment, the image capture unit 222 can also have the function of temperature detection. The image capture unit 222 can sense the temperature of the object to generate image containing the temperature information TMP, so that the monitoring apparatus 222 can obtain the temperature information TMP via the image.

Referring further to FIG. 2, the apparatus control unit 226 is, for instance, an infrared remote control including an infrared light-emitting diode. The apparatus control unit 226 is coupled to the processing unit 223, and can control a plurality of electronic apparatuses in the environment that the object is located, such as an air conditioner, a lamp, a television, a cleaning robot, and other electronic apparatuses. When the handheld electronic apparatus 210 receives the status information of the object transmitted by the monitoring apparatus 220, the handheld electronic apparatus 210 can receive the remote operation performed on the monitoring apparatus 220 by the user according to the status information to generate a control signal, so as to control the electronic apparatuses via the apparatus control unit 226, and thereby improve various conditions (such as adjusting the intensity of an air conditioner, adjusting the brightness of a lamp, adjusting the volume of a television, and turning off a cleaning robot) of the environment that the object is located.

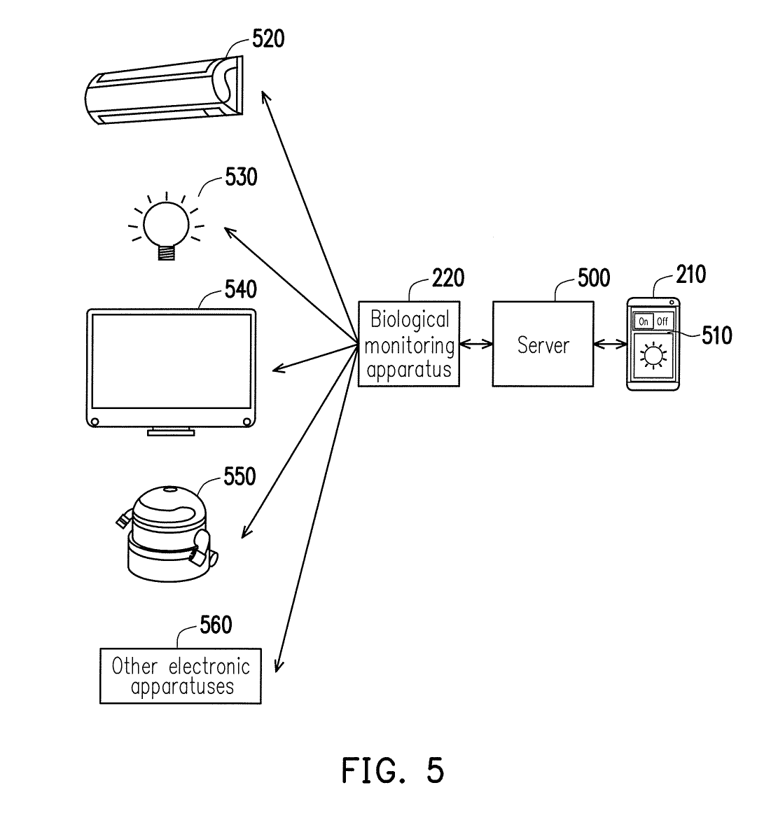

In the following, an example of the control of an electronic apparatus is described with reference to FIG. 2 and FIG. 5, wherein FIG. 5 illustrates a schematic of the implementation of the control of an electronic apparatus of an embodiment of the invention. In FIG. 5, after the monitoring apparatus 220 generates the status information of the object, the status information is transmitted to the handheld electronic apparatus 210 via the communication unit 224 through the server 500. At this point, the handheld electronic apparatus 210 can execute an application 510 (as shown in FIG. 5, a screen displaying opening, closing, and adjustment) to receive a remote operation performed on the monitoring apparatus 220 by the user according to the status information of the object. In an embodiment, the handheld electronic apparatus 210 can obtain a control signal via the server 500 having a plurality of pre-stored control signals. Specifically, when the handheld electronic apparatus 210 receives the remote operation performed on the monitoring apparatus 220 by the user, the controlled electronic apparatus can be selected from a plurality of electronic apparatuses (an air conditioner 520, a lamp 530, a television 540, a cleaning robot 550, and other electronic apparatuses 560) and control parameters suitable for the controlled electronic apparatus can be set, such as various parameters for, for instance, switch control, temperature adjustment, brightness adjustment, and volume adjustment. Therefore, the handheld electronic apparatus 210 can compare the set control parameters with the control signals pre-stored in the server 500, and obtain the corresponding control signal via the server 500 and transmit the control signal to the monitoring apparatus 220. Lastly, the apparatus control unit 226 can control a suitable electronic apparatus according to the control signal to improve various conditions in the environment that the object is located.

Moreover, in an embodiment, the microphone 227 in the monitoring apparatus 220 can be configured to receive a sound signal in the environment that the object is located as one of the bases (such as crying of a newborn infant) for the determination of the physical condition of the object by the processing unit 223. Moreover, the speaker 228 can play a sound (such as the soothing voice of a mother) according to the status information, so as to take appropriate measures according to the condition of the object.

It should be mentioned that, in the operation of an embodiment, the processing unit 223 can first control the radar 221 to generate the electromagnetic wave, and then trigger the image capture unit 222 according to the reflected wave of the electromagnetic wave to capture the image. In the present embodiment, during the period in which the processing unit 223 controls the radar 221 to generate the electromagnetic wave, the processing unit 223 can first turn off the image capture unit 222. Moreover, the processing unit 223 can determine whether the information of the radar 221 generated by the reflected wave is sufficient to determine a change of the object. When the generated information is insufficient to determine a change of the object, the processing unit 223 turns the image capture unit 222 back on to capture image of the object to further monitor the object.

Similarly, as needed, the processing unit 223 can also control the image capture unit 222 to capture the image first, and then determine whether the radar 221 needs to be triggered to generate the electromagnetic wave according to the image, so as to further monitor the object.

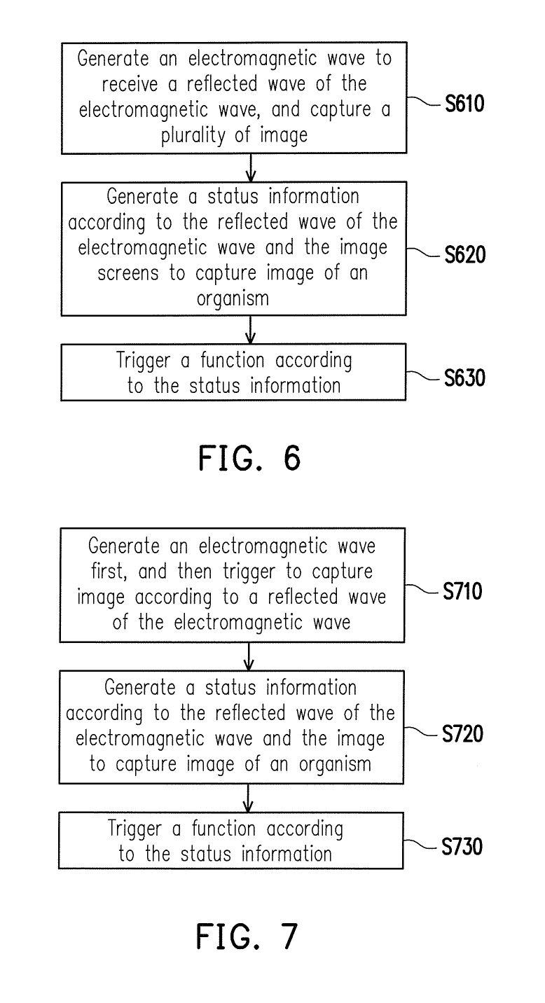

Referring to FIG. 6 in the following, FIG. 6 illustrates a flow chart of a monitoring method of an embodiment of the invention. In step S610, an electromagnetic wave is generated to receive a reflected wave of the electromagnetic wave, and a plurality of image is captured. Moreover, in step S620, a status information is generated according to the reflected wave of the electromagnetic wave and the image. Then, in step S630, a function is triggered according to the status information.

In an embodiment, during the monitoring of the object, the electromagnetic wave can be generated first, and then triggering occurs according to the reflected wave of the electromagnetic wave to capture image. Referring to FIG. 7 in the following, FIG. 7 illustrates a flow chart of a monitoring method of an embodiment of the invention. In step S710, an electromagnetic wave is generated first, and then triggering occurs according to a reflected wave of the electromagnetic wave to capture image. Moreover, in step S720, a status information is generated according to the reflected wave of the electromagnetic wave and the image. Then, in step S730, a function is triggered according to the status information.

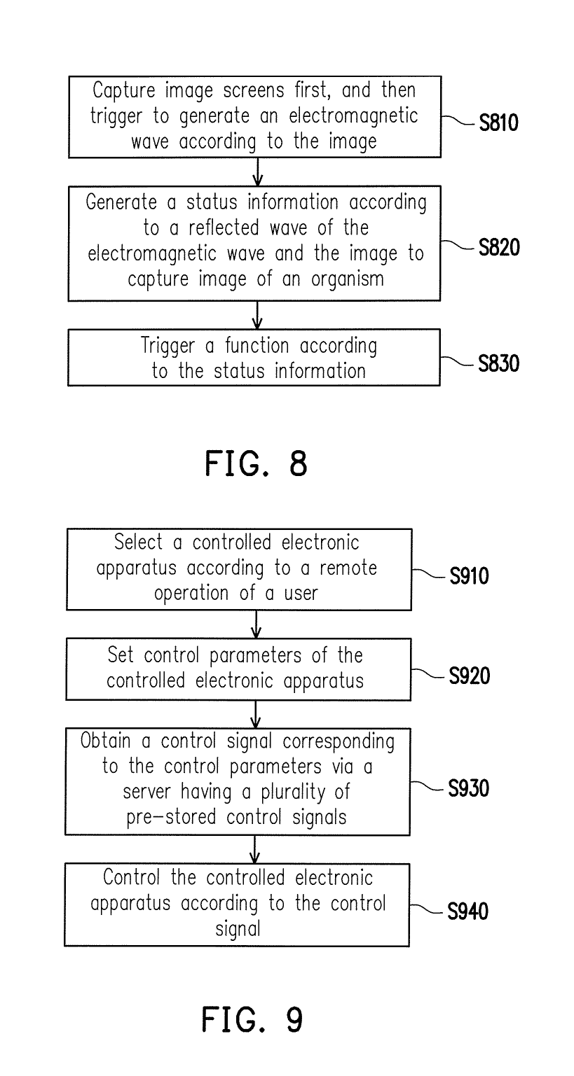

Similarly, as needed, during the monitoring of the object, the image can also be captured first, and then triggering occurs according to the image to generate the electromagnetic wave. Referring to FIG. 8 in the following, FIG. 8 illustrates a flow chart of a monitoring method of an embodiment of the invention. In step S810, image are captured first, and then triggering occurs according to the image to generate an electromagnetic wave. Moreover, in step S820, a status information is generated according to a reflected wave of the electromagnetic wave and the image. Then, in step S830, a function is triggered according to the status information.

Moreover, after steps S630, S730, and S830, the generated status information can be transmitted to the handheld electronic apparatus. Moreover, the remote operation performed on the monitoring apparatus by the user according to the status information is received via the handheld electronic apparatus, and a plurality of electronic apparatuses in the environment that the object is located is controlled according to the remote operation.

Referring to FIG. 9 in the following, FIG. 9 illustrates a flow chart of a monitoring method of another embodiment of the invention. Specifically, the method of controlling the plurality of electronic apparatuses in the environment that the object is located according to the remote operation can include, for instance, the following steps. In step S910, a controlled electronic apparatus is selected according to a remote operation of a user. Then, in step S920, control parameters of the controlled electronic apparatus are set. Moreover, in step S930, a control signal corresponding to the control parameters is obtained via a server having a plurality of pre-stored control signals. Moreover, in step S940, the controlled electronic apparatus is controlled according to the control signal.

Moreover, in FIG. 6, FIG. 7, FIG. 8, and FIG. 9, the details of the executing steps of the monitoring method are described in the plurality of embodiments and the plurality of implementations above, and are therefore not repeated herein.

Based on the above, in the invention, a change in a characteristic of an object can be monitored via the application of a radar, and the physical condition of the object can be accurately determined with image. Moreover, combined with the property of a handheld electronic apparatus that can be easily carried, the user can be always in control of the condition of the object in a convenient manner and take appropriate measures, so as to prevent discomfort or danger to the object (such as a newborn infant).

What is claimed is:

1. A monitoring system, comprising:
a handheld electronic apparatus; and
a monitoring apparatus wirelessly connected to the handheld electronic apparatus, wherein the monitoring apparatus comprises:
a radar generating an electromagnetic wave and receiving a reflected wave of the electromagnetic wave;
an image capture unit being configured to capture a plurality of image; and
a processing unit coupled to the radar and the image capture unit, wherein the processing unit generates a status information according to the reflected wave of the electromagnetic wave and the image, wirelessly transmits the status information to the handheld electronic apparatus, and the handheld electronic apparatus triggers a function according to the status information.

2. The monitoring system of claim 1, wherein the radar monitors a change in an object according to the reflected wave, and the processing unit determines the change of the object according to the reflected wave and the image containing the object to generate the corresponding status information.

3. The monitoring system of claim 2, wherein the handheld electronic apparatus executes at least one application corresponding to the status information to execute the function.

4. The monitoring system of claim 1, wherein the monitoring apparatus further comprises:
a first communication unit coupled to the processing unit and establishing a connection with the handheld electronic apparatus,
wherein the processing unit transmits the status information to the handheld electronic apparatus via the first communication unit.

5. The monitoring system of claim 1, wherein the monitoring apparatus further comprises:
an apparatus control unit coupled to the processing unit and controlling a plurality of electronic apparatuses,
wherein the handheld electronic apparatus generates a control signal according to the status information, and the monitoring apparatus controls the electronic apparatuses via the apparatus control unit according to the control signal.

6. The monitoring system of claim 5, further comprising a server, wherein the server stores a plurality of control signals, the handheld electronic apparatus obtains the control signal via the server, and the monitoring apparatus controls the electronic apparatuses via the apparatus control unit according to the control signal.

7. The monitoring system of claim 2, wherein the change of the object comprises a temperature of the object, the monitoring system further comprising:
a temperature detector, comprising:
a sensing unit sensing the temperature of the object to generate a corresponding temperature information; and
a second communication unit transmitting the temperature information to the monitoring apparatus.

8. The monitoring system of claim 2, wherein the change of the object comprises a temperature of the object, and the image capture unit senses the temperature of the object to generate the image containing a temperature information.

9. The monitoring system of claim 2, wherein the change of the object comprises a respiratory rate of the object, and the processing unit determines whether a posture of the object is poor according to the respiratory rate of the object and the image to generate the corresponding status information.

10. The monitoring system of claim 1, wherein the monitoring apparatus further comprises:
a microphone receiving at least one sound signal; and
a speaker playing a sound according to the status information.

11. The monitoring system of claim 2, wherein the processing unit first controls the radar to generate the electromagnetic wave, and then triggers the image capture unit according to the reflected wave of the electromagnetic wave to capture the image.

12. The monitoring system of claim 2, wherein the processing unit first controls the image capture unit to capture the image, and then triggers the radar according to the image to generate the electromagnetic wave.

13. A monitoring apparatus, comprising:
a radar generating an electromagnetic wave and receiving a reflected wave of the electromagnetic wave;
an image capture unit configured to capture a plurality of image; and
a processing unit coupled to the radar and the image capture unit, wherein the processing unit generates a status information according to the reflected wave of the electromagnetic wave and the image, wirelessly transmits the status information to a handheld electronic apparatus, and the handheld electronic apparatus triggers a function according to the status information.

14. The monitoring apparatus of claim 13, wherein the radar monitors a change in an object according to the reflected wave, and the processing unit determines the change of the object according to the reflected wave and the image containing the object to generate the corresponding status information.

15. The monitoring apparatus of claim 14, wherein the handheld electronic apparatus executes at least one application corresponding to the status information to execute the function.

16. The monitoring apparatus of claim 13, further comprising:
a communication unit coupled to the processing unit and establishing a connection with the handheld electronic apparatus,
wherein the processing unit transmits the status information to the handheld electronic apparatus via the communication unit.

17. The monitoring apparatus of claim 13, further comprising:
an apparatus control unit coupled to the processing unit, and the monitoring apparatus controlling a plurality of electronic apparatuses via the apparatus control unit according to a control signal generated by the handheld electronic apparatus.

18. The monitoring apparatus of claim 17, wherein the handheld electronic apparatus obtains the control signal via a server storing a plurality of control signals, and the monitoring apparatus controls the electronic apparatuses via the apparatus control unit according to the control signal.

19. The monitoring apparatus of claim 18, wherein the monitoring apparatus is wirelessly connected to the server, and the handheld electronic apparatus receives the status information related to a change in an object via the server.

20. The monitoring apparatus of claim 14, wherein the change of the object comprises a temperature of the object, and the monitoring apparatus receives a temperature information generated by a temperature detector from sensing the temperature of the object.

21. The monitoring apparatus of claim 14, wherein the change of the object comprises a temperature of the object, and the image capture unit senses the temperature of the object to generate the image containing a temperature information.

22. The monitoring apparatus of claim 14, wherein the change of the object comprises a respiratory rate of the object, and the processing unit determines whether a posture of the object is poor according to the respiratory rate of the object and the image to generate the corresponding status information.

23. The monitoring apparatus of claim 13, further comprising:
a microphone receiving at least one sound signal; and
a speaker playing a sound according to the status information.

24. The monitoring apparatus of claim 14, wherein the processing unit first controls the radar to generate the electromagnetic wave, and then triggers the image capture unit according to the reflected wave of the electromagnetic wave to capture the image.

25. The monitoring apparatus of claim 14, wherein the processing unit first controls the image capture unit to capture the image, and then triggers the radar according to the image to generate the electromagnetic wave.

26. A monitoring method, comprising:
generating an electromagnetic wave to receive a reflected wave of the electromagnetic wave, and capturing a plurality of image;
generating a status information according to the reflected wave of the electromagnetic wave and the image; and
triggering a function according to the status information.

27. The method of claim 26, further comprising, after the step of receiving the reflected wave of the electromagnetic wave:
monitoring a change in an object according to the reflected wave.

28. The method of claim 27, wherein the step of generating the status information according to the reflected wave of the electromagnetic wave and the image comprises:
determining the change of the object according to the reflected wave and the image containing the object to generate the corresponding status information.

29. The method of claim 28, further comprising, after the step of generating the status information:
executing at least one application corresponding to the status information via a handheld electronic apparatus to execute the function.

30. The method of claim 26, further comprising:
establishing a connection with a handheld electronic apparatus.

31. The method of claim 26, further comprising, after the step of generating the status information:
generating a control signal via a handheld electronic apparatus according to the status information; and
controlling a plurality of electronic apparatuses according to the control signal.

32. The method of claim 31, wherein the step of generating the control signal comprises:
obtaining the control signal via a server, wherein the server stores a plurality of control signals.

33. The method of claim 28, wherein the change of the object comprises a temperature of the object, and the method further comprises, after the step of determining the change of the object according to the reflected wave and the image containing the object to generate the corresponding status information:
detecting the temperature of the object to generate a temperature information.

34. The method of claim 28, wherein the change of the object comprises a temperature of the object, and the method further comprises, after the step of determining the change of the object according to the reflected wave and the image containing the object to generate the corresponding status information:
detecting the temperature of the object to generate the image containing a temperature information.

35. The method of claim 28, wherein the change of the object comprises a respiratory rate of the object, and the method further comprises, after the step of determining the change of the object according to the reflected wave and the image containing the object to generate the corresponding status information:
determining whether a posture of the object is poor according to the respiratory rate of the object and the image to generate the corresponding status information.

36. The method of claim 28, further comprising, after the step of determining the change of the object according to the reflected wave and the image containing the object to generate the corresponding status information:
receiving at least one sound signal in an environment that the object is located; and
playing a sound according to the status information corresponding to the sound signal.

37. The method of claim 28, wherein the step of generating the electromagnetic wave to receive the reflected wave of the electromagnetic wave and capturing the image comprises:
generating the electromagnetic wave first, and then triggering to capture the image according to the reflected wave of the electromagnetic waves.

38. The method of claim 28, wherein the step of generating the electromagnetic wave to receive the reflected wave of the electromagnetic wave and capturing the image comprises:
capturing the image first, and then triggering to generate the electromagnetic wave according to the image.
